(19) United States
(12) Patent Application Publication
(10) Pub. No.: US 2014/0040159 A1
(43) Pub. Date: Feb. 6, 2014

(54) COMMON DOCUMENT HEADER FOR A BUSINESS MANAGEMENT PLATFORM

(71) Applicant: Rockton Software, Inc., Sandpoint, ID (US)

(72) Inventors: Guy P. Caron, Great Falls, VA (US); Mark H. Rockwell, Erie, CO (US)

(73) Assignee: Rockton Software, Inc., Sandpoint, ID (US)

(21) Appl. No.: 13/952,422

(22) Filed: Jul. 26, 2013

Related U.S. Application Data
(60) Provisional application No. 61/677,953, filed on Jul. 31, 2012.

(51) Int. Cl. G06Q 40/00

(52) U.S. Cl. CPC G06Q 40/00
USPC 705/342

(57) ABSTRACT

Systems and methods of implementing a common document header for a business management platform are disclosed. An example method includes receiving data via a plurality of separate data entry points to a business management platform, the data describing at least some financial information and some operational information for a business. The method also includes generating a common document header (CDH) to organize and uniformly handle the data by the business management platform. The method also includes maintaining a current status of the data in the CDH. The method also includes driving a business action by the business management platform based on the current status of the data organized in the CDH. Other examples of implementing a common document header for a business management platform are also disclosed.

### CROSS REFERENCE TO RELATED APPLICATIONS AND PRIORITY CLAIM

This application claims the priority benefit of U.S. Provisional Patent Application No. 61/677,953 filed Jul. 31, 2012 for “Common Document Header For Financial Systems,” of Caron, et al., and is related to U.S. Provisional Patent Application No. 61/800,052 filed Mar. 15, 2013 for “Operational Reporting for Financial Systems,” of Caron, et al., each of which is hereby incorporated by reference in their entirety as though fully set forth herein.

### BACKGROUND

Financial software enables businesses to handle various aspects of their finances such as, but not limited to bookkeeping, auditing, and reporting. A common type of financial software handles data (e.g., from requisitions, purchase orders (POs), invoicing, and receiving) as sub-ledgers which feed into a higher-level ledger, commonly referred to as a “general ledger” (GL).

The GL provides an overview of the various business finances. However, when data is updated in one of the sub-ledgers, this updated data may not accurately populate to the GL. For example, when data is copied from a sub-ledger, the copy may be incomplete or include error(s), causing data to be out of sync.

Over time, the GL may become corrupt. Significant accounting resources are often needed to track down and correct the problem. These accounting resources may be outsourced to accountants and/or bookkeepers, or handled as part of in-house team. In either case, accounting resources are often expensive; but ignoring the problem can be even more costly.

### BRIEF DESCRIPTION OF THE DRAWINGS

FIG. 1 is a high-level block diagram of an example operating environment including a business management platform implementing a common document header (CDH).

FIG. 2 shows an example architecture of an example business management platform implementing a common document header (CDH)

FIG. 3 illustrates various processes and datasets of an accounts payable (AP) invoice data entry and general ledger (GL) tables which may be used by an example business management platform implemented as a financial or accounting system.

FIG. 4 is a process flow diagram illustrating flow of data from ledgers to posting data into a data-warehouse and reporting cubes for an example a business management platform implemented as a financial or accounting system with a CDH.

FIG. 5 illustrates an example process enabled by a business management platform using a common document header (CDH).

FIG. 6 is a flowchart illustrating example operations to implement a common document header (CDH) for a business management platform.

FIGS. 7a-c are flowcharts illustrating example operations to implement a common document header (CDH) for a business management platform.

### DETAILED DESCRIPTION

Systems and methods are described herein which include a business management platform which implements a common document header (CDH) to manage data. Example business management platforms may include, but are not limited to business financial system(s) and business operations system(s). When implemented as part of a financial system and/or business operations system, the data in various distribution tables may be organized according to the CDH for use by a reporting mechanism (e.g., a general ledger (GL)) or other processing module. Organizing data according to a CDH for use by other modules reduces or altogether eliminates the need to populate data from the various distribution tables directly into the reporting mechanism (e.g., the GL) or other processing module.

The ability to store business data in a common format according to the CDH simplifies the process of making this data available to other modules, e.g., for reporting, feeding into other components of the business management platform, and/or interacting with other systems and processes. Implementation of the CDH may also reduce or altogether eliminate data corruption in the business management platform, thereby reducing the need and associated costs of accounting and other resources to identify and correct errors.

In an example, the systems and methods described herein may be enabled via an extensible architecture. The extensible architecture is further enabled by the use of a CDH, and allows other developers to integrate legacy systems, vendor-specific software, add-on modules, and/or output formats (e.g., reporting documents), to be used with the business management platform. Accordingly, a core product can be readily expanded for use with custom or proprietary systems, and to leverage cross-platform synergies.

Although the various examples used for purposes of illustration herein are described primarily with reference to financial systems and/or business operations systems, it is noted that the disclosure is not limited to any particular type of business management platform. Other implementations of the systems and methods will become readily apparent to those having ordinary skill in the art after becoming familiar with the teachings herein.

Before continuing, it is noted that as used herein, the terms “includes” and “including” mean, but are not limited to, “includes” or “including” and “includes at least” or “including at least.” The term “based on” means “based on” and “based at least in part on.”

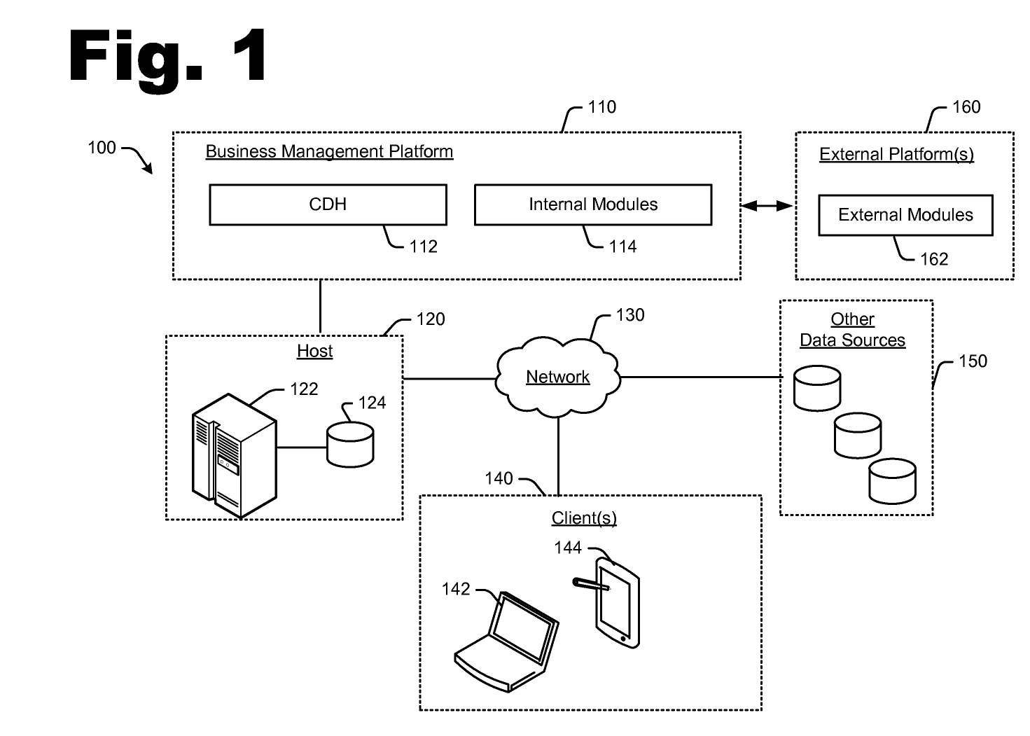

FIG. 1 is a high-level block diagram of an example operating environment 100 including a business management platform 110 implementing a common document header (CDH) 112. The example operating environment 100 may implement the systems and methods disclosed herein using any of a wide variety of host and/or client computing devices, such as, but not limited to, stand-alone or hosted server computers, desktop/laptop/workstations, mobile devices, and appliances (e.g., devices dedicated to providing a service such as storage), to name only a few examples.

Each of the computing devices implemented by the example operating environment 100 may include memory, storage, and a degree of data processing capability at least sufficient to manage a communications connection either directly with one another or indirectly (e.g., via a network). At least one of the computing devices is also configured with sufficient processing capability to execute the program code described herein.

Although, it is noted that the operations described herein may be executed by program code residing on any suitable computing device, in some instances (e.g., where the client is a tablet or mobile device) the operations may be better performed at least in part on a separate computer system having more processing capability, such as a server computer or plurality of server computers referred to herein generally as a host 120.

In example operating environment 100, the host 120 may be configured as computing device(s) 122 with a processor (not illustrated separately) and computer-readable storage 124. For example, the host 120 may be implemented as one or more server computer or stand-alone computing device (e.g., a personal computer). Of course, the computing devices described herein are not limited in function, and may provide other services, such as transaction processing.

In an example, the business management platform is stored as machine readable instructions stored on non-transient or non-transitory computer readable media (e.g., storage 124) and executable by a processor (e.g., processor of computing device 122). The machine readable instructions may be self-standing and/or embodied as agents accessed by an existing system. The business management platform 110 may be implemented to provide financial, operational, and/or other business management services. Example business management services may include, but are not limited to, general accounting (e.g., bookkeeping, auditing, and reporting), budgeting/forecasting, purchasing, invoicing, and employee expense accounts.

The business management platform 110 may be implemented for any size business, from a sole proprietor to a small/medium/large size business. In addition, the business management platform 110 may be implemented locally (e.g., at an individual office), across satellite offices or separate divisions, and/or globally. When implemented in geographically dispersed locations, the business management platform 110 may include more than one installation at the different sites and/or may be provided as a hosted solution, e.g., via a computing network (e.g., the Internet) or in the “cloud.”

For purposes of illustration, the business management platform 110 is shown as it may be provided in a networked computer environment via network 130. Accordingly, user(s) may access functionality of the business management platform 110 from any suitable client device 140, such as a laptop computer 142 or mobile phone 144. User(s) may also provide data to the business management platform 110 via their individual computing device(s). For example, an employee may record expense reports remotely during travel, and send those expense reports from a mobile device connected via any suitable network to the business management platform 110.

The business management platform 110 may also receive data from other data sources 150. The data sources may include any local and/or remote data source. That is, the data source may be stored physically local to the business management platform 110 (e.g., on an attached hard disk drive or other storage medium). The data source may also be physically distributed in the network 130 (or across multiple networks, not shown). For example, the data source may be a data storage facility including interfaces for providing read/write access to the data.

While illustrated herein primarily with reference to business financial and operational data, the data may be any suitable type of data which may be processed according to the systems and methods described herein. In addition, the data provided by the various sources may be any format, and may include “raw” or unprocessed data, and/or data which has undergone at least some level of pre-processing prior to use by the business management platform 110.

The business management platform 110 may organize data according to a common document header (CDH) 112. CDH 112 enables the business management platform 110 to handle data from a variety of sources by simplifying and consolidating the data, e.g., to promote better organization, reduce redundancy, improve accuracy, support internal and external transactions, and promote standardized transactions within the same platform and across different platforms.

The business management platform 110 may be modular in nature. For example, the business management platform 110 may include internal module(s) 114 to provide the functionality described herein. Business management platform 110 may also operate across platforms, such as with external platform(s) 160 and/or external module(s) 162, to enable use with other application engines and/or hosted business services (e.g., online payment systems).

In an example, the business management platform 110 may implement a common document header (CDH) as follows. The business management platform 110 may receive data via a plurality of separate data entry points to a business management platform. The data describes at least some financial information and/or some operational information for a business. A CDH may be generated to organize and uniformly handle the data by the business management platform 110. For example, the business management platform 110 may maintain a current status of the data in the CDH, and drive a business action by the business management platform based on the current status of the data organized in the CDH (e.g., a sum of items corresponding to various statuses exceeding a budget).

The CDH may have a status (e.g., Requisition, Committed, Pending, and Actual), which can be changed/updated. The sum of these items associated with these statuses (e.g., Requisition, Committed, Pending, and Actual) may be compared at any given time, to actual activity to derive a total. For example, the total may be the sum of all accounts of various status (e.g., Requisition, Committed, Pending, and Actual), and the total can be compared to the budget. Any item can be included and/or excluded at any time, for comparison to the budget.

For purposes of illustration, consider a contract negotiation use-case wherein a company has an annual operating budget. An employee is in the field negotiating a contract to purchase office equipment. During initial negotiations, the employee is considering a $20,000 purchase from vendor A, and a $10,000 purchase from vendor B. The employee enters these contracts as purchase orders (or sales orders) and the status is set to Requisition. These purchases would be considered to be within budget and therefore would be approved. However, when negotiations proceed, the contract total is $40,000. Using the business management system described herein, the employee enters this new amount for the purchase orders (e.g., via mobile device in the field) prior to signing the contract. Because this amount exceeds the budget, an alert is generated and issued (e.g., to the employee and/or financial manager and/or other designated person at the company). At this point, the company either has to find other funds in the budget, or revise/cancel the current contract negotiations because a Requisition has been submitted that would exceed the company's budget.

Thus it can be seen that a collection of statuses lets the user drive operational issues in real-time, instead of waiting for information to flow through to the GL (at which time it may be too late to take corrective action). The appropriate managers can be instantly alerted that they will go over budget if a contract were to go through.

Although described above with reference to a contract negotiation illustration, it will be understood by those having ordinary skill in the art after becoming familiar with the teachings herein how the business management system with CDL can be applied to other use-cases (e.g., employees submitting expense reports in real-time or substantially in real-time). Still other use-cases will also be apparent from the description given herein.

To illustrate operation of the business management platform 100, a transaction may include primary information (e.g., a dollar amount), and secondary information such as a source of the primary information (e.g., employee ID, office location, etc.), a time/date that the primary information was generated/acquired, and a status of the transaction (e.g., pending/confirmed).

The transaction may be financial, operational, or other in nature. Example transaction types may include, projects, time entries, employee count at an office, employee vacation or sick days, property/plant/equipment tracking data, and leads in a sales process, to name only a few examples.

After receiving the data, the business management platform 110 generates one or more (or adds to an existing) CDH and records the transaction (including both the primary and secondary data). The business management platform may also maintain (e.g., update or change) a status of the transaction. Example status of the transaction include incomplete, requisition, committed, pending, or posted, to name only a few examples.

The business management platform may be further operated to drive a business action, e.g., based on the status of the transaction. Generating reports (e.g., a GL) are one example of a business action. Other example business actions may include, but are not limited to, assigning a task, cutting a check, and creating another transaction.

Business actions may also include issuing a notification or alarm (e.g., if validation rules for a given document causes an error). By way of illustration, if an invoice is recorded for outbound sales and the distribution includes an account that does not pertain to Accounts Receivables (AR) when the transaction is pending, then the business management platform may notify a user that the AR module will become out of balance by adding this transaction. In this case, the change of status may be stopped from being Posted (as Posting may cause an error requiring research to determine why the AR account(s) or AR balance(s) are out of balance).

As another illustration, if a check is cut on a bank account, but the distribution is not on an account that is part of the checkbook, the business management platform may generate an alert that the checkbook balance will be out of sync with the balance in the GL. Such an alert allows for real-time notification of account reconciliation.

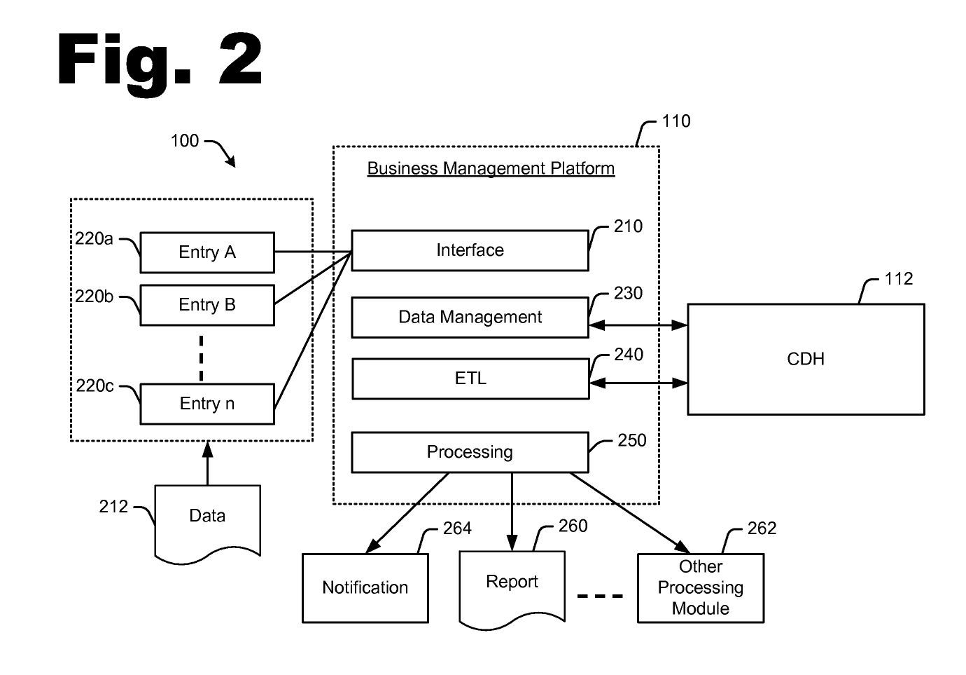

Other aspects and uses of the business management platform 110 and CDH 112 are also contemplated, and the above examples are only provided by way of illustration. Example program code 130 used to implement these and other features of the system can be better understood with reference to FIG. 2 and the following discussion of various example functions.

FIG. 2 shows an example architecture of an example business management platform 110 implementing a common document header (CDH). Although described with reference to example functional modules, it is noted that various application programming interfaces (APIs) and related support infrastructure may also be provided. It is also noted that the operations described herein are not limited to any specific implementation with any particular type of program code.

The business management platform 110 may be implemented as program code, and may include one or more modules as illustrated in FIG. 2. In the example shown in FIG. 2, the business management platform 110 includes an interface module 210 to receive data 212 via a plurality of separate data entry points 220a-c to the business management platform 110. In an example, the data describes at least some financial information and some operational information for a business.

The business management platform 110 also includes a data management module 230. The data management module generates a common document header (CDH) 112 to organize and uniformly handle the data. The data management module 230 may also maintain a current status of the data in the CDH 112.

A “common document header” (or CDH) 112 as the term is used herein refers to a data structure used to store and identify key information about data. The CDH enables standardized data handling, including but not limited to data storage, data retrieval, data operations, routing or passing data between modules, and presentation to an end user. The header may be applied to the data prior to any data handling, and remain with the data throughout data processing. The elements used to identify the data enable the data to be centrally stored and managed, and readily located and leveraged across multiple modules and/or applications. The elements of the CDH 112 may include mandatory elements provided in a definition file. The definition file may also be updated to add other (e.g., optional) elements for data handling. Independent software vendors (ISVs) or developers can develop functionality based on the definition of the CDH to handle data transparently to the end-user.

The business management platform 110 also includes an extract transform load (ETL) module 240 to extract the data from the CDH 112, and a processing engine 250. The ETL module 240 may be responsible for retrieving data requested by an end-user and/or other module. The ETL module 240 may retrieve data according to elements defined in the definition file and format the data for the requesting module. The processing engine may process and output the extracted data to any of a plurality of modules, e.g., to drive a business action based on the current status of the data organized in the CDH. For example, the processing engine 250 may generate a report 260, or feed output data to another module 262 for further processing. The processing engine 250 may also be operatively associated with a notification module 264. The notification module 264 may issue a notification or alert (e.g., an email or other user message) to notify a user or other component of the business management platform 110 of an issue with the data processing. In any event, it can be seen that all data is pulled according to the CDH and thus there is no need to establish independent work tables and/or update data between work tables.

In an example, the business management platform 110 implementing a CDH 112 to provide an extensible architecture. An extensible architecture allows other developers to integrate legacy systems, vendor-specific software, add-on modules, and/or output formats (e.g., reporting documents), with the business management platform 110, thereby expanding application of the business management platform 110 to custom or proprietary systems.

In an example, data is recorded in the CDH 112 as a transaction having a standard set of attributes (e.g., a date, amount, description). Specific attributes may be used to allow for vertical applications to import, leverage, and use data from the business management platform that is available in the CDH 112.

By way of illustration, the business management platform 110 may be considered the core product, and also has the following modules available (e.g., as internal modules 114 in FIG. 1 and/or external modules 162 in FIG. 1): General Ledger (GL), Accounts Receivable (AR), Accounts Payable (AP), and Treasury Management (TM). A general ledger transaction may be processed by the GL module. The customer can leverage the core product by having their own product, such as a project management (PM) module and/or other modules such as Timesheet (TS), Expenses (EX), Project Purchases (PP).

Transactions can be imported as an outside source, or can be built on the same platform and seemingly integrate into the core product. The end-user need not know that the timesheets are not part of the core product and has available the distributions, fiscal periods and status available to all of the CDH data (e.g., Requisition, Committed, Pending, and Posted).

For example, a timesheet transaction may be Committed before it is approved by the user keying the timesheet. The timesheet can be moved to Pending once the manager approves it. The timesheet can then be posted once accounting processes it. The reporting mechanism in the business management platform enables a project to have values for time spent (count of hours) and cost and billing amount reported to the project instantaneously, and can be available for operational reporting (e.g., if the user desires), even though these entries may still have to be approved on the accounting side.

In an example, the CDH 112 can be a multiple dimension CDH, with each dimension defining an independent business classification. In addition, any transaction can be further annotated (e.g., to describe an associated parameter). For example, a transaction for an employee expense is typically recorded to a GL account for travel. However, it may be useful to have additional information about this transaction. Accordingly, the business management system may create two dimensions for the CDH 112: one for Employee and another for Project. The employee dimension includes information about the employee (e.g., Employee ID and State where employee is located). The project dimension includes information about the project (e.g., Project Number, Project Manager and Project Location).

For certain transactions, the user may be required to enter information for one or more dimensions. For example, when an employee expense is received by the system, the hotel/transportation accounts may require both the employee number and the corresponding project number to be entered. Because the project dimension holds values for project manager and location of start dates, and the employee dimension holds the location of the employee, the system automatically obtains the supplemental information. By way of illustration, the CDH may be populated with the following information: Employee expense $150; Project# ABC; Employee ID 345. A dataset may then be generated based on other information available to the business management platform 110 to output the following example report:

Project Report:
i. Expense $150
ii. Expense GL account 7520
iii. Project# ABC
iv. Project Location Boulder CO (*)
v. Project Manager John Smith (*)
vi. Employee Suzy Williams
vii. Employee Location (*)

In the example report shown above, the data indicated by the asterisk (*) was derived based on input information and other information available to the system (e.g., based on Project#).

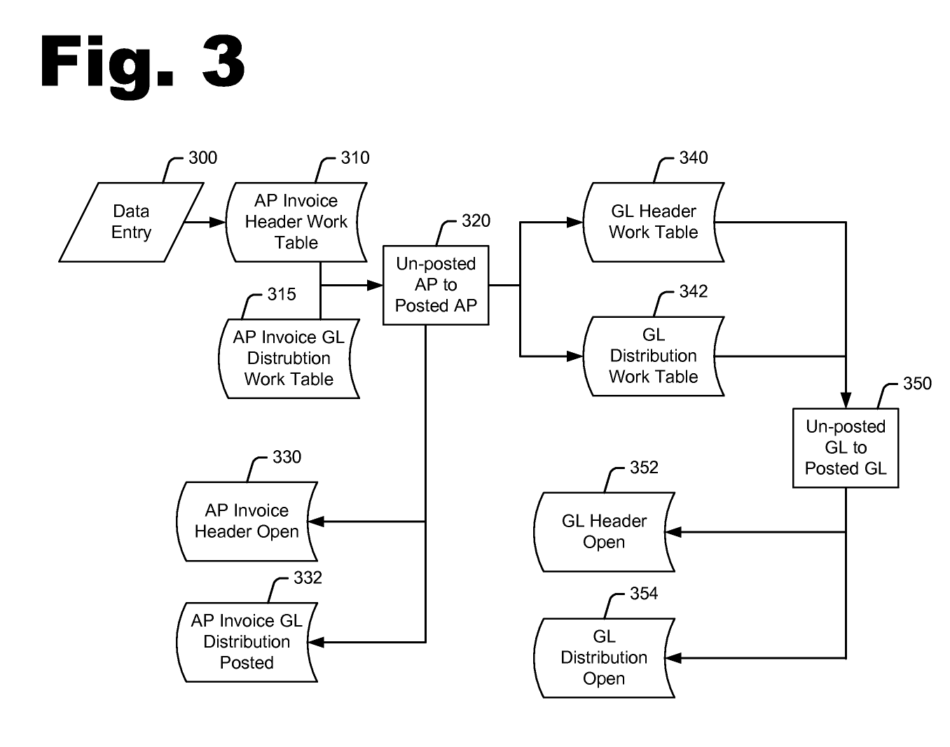

FIG. 3 illustrates various processes and datasets of an accounts payable (AP) invoice data entry and general ledger (GL) tables which may be used by an example a business management platform implemented as a financial or accounting system. In this illustration, data may be received via at an invoice data entry module (e.g., user input screen) to the AP Invoice header 310, and then posted along with AP Invoice 332 to the GL distribution work table 315.

A typical AP system stores data in work tables. The work tables contain detail distributions that are forwarded to the GL once posted. When the invoice is approved for posting 320, the process stores the distribution information in the AP Header Open 330 or AP History tables (not depicted) in order to keep information about the invoices in the accounts payable. See for example, the arrows in FIG. 3 to table AP Invoice Header Open and AP Invoice GL distribution Posted.

During the same process, the resulting General Ledger transactions are posted in the General Ledger header work table 340 and GL distribution work table 342. These tables are copies of the AP Invoice GL distribution work table 315 in the prior step. In turn the GL header work table 340 and GL distribution work table 342 are posted 350 to the GL header open work table 352 and GL distribution open work table 354.

It is noted that the work tables may have the data purged after being posted to the Posted Open or History data tables. It is also noted that the AP Invoice GL Distribution Posted and the GL Distribution Open are initially copies of each other, but residing in respective modules AP and GL.

According to this model, the GL may be altered, causing the GL to be out-of-sync with data in the AP module unless these changes are reconciled between the two modules. In addition, corrections made in the GL are not necessarily reflected in the AP module. If a distribution is inaccurate (such as the expense of an Accounts Payable was recorded incorrectly), then two sets of tables need to be updated.

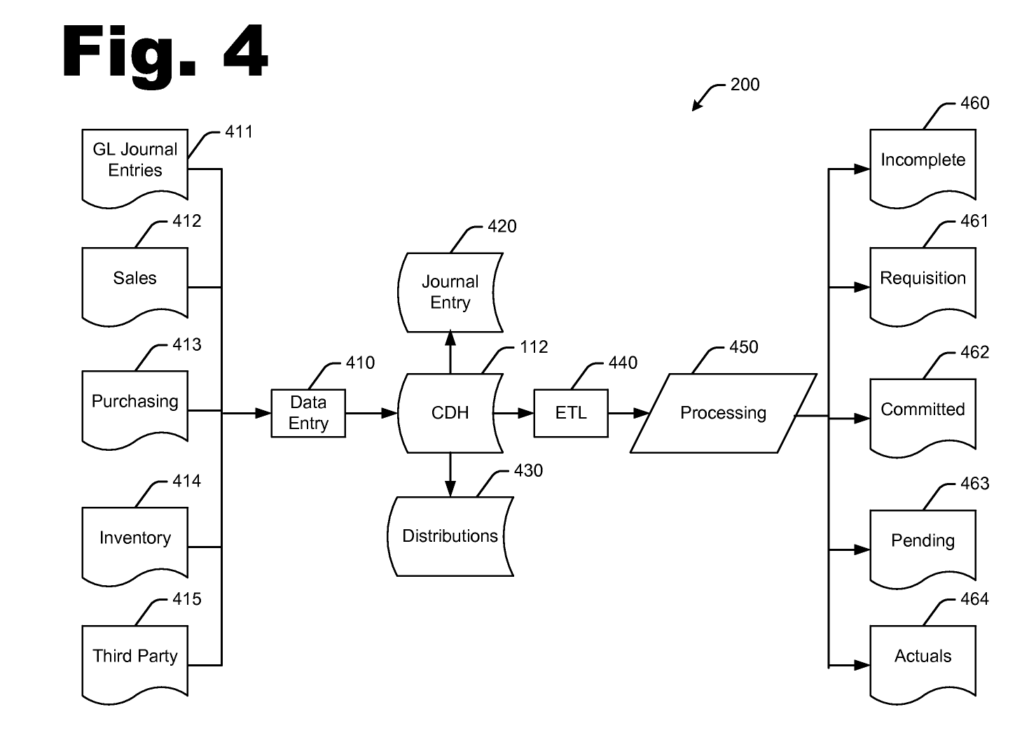

FIG. 4 is a process flow diagram illustrating flow 400 of data from ledgers to posting data into a data-warehouse and reporting cubes for an example a business management platform implemented as a financial or accounting system with a CDH 112. By implementing a CDH 112, the process described above with reference to FIG. 3 can be simplified, reducing or altogether eliminating the need to establish and maintain work tables and associated data processing, in this example in a financial or accounting system.

As shown in FIG. 4, the accounts payable (AP) data entry is received at the business management platform via an AP data entry point 410 (e.g., a manual data entry window, or automatically from a data store). Data may include by way of example, but not limited to GL journal entries 411; Sales documents quote, order shipment, sales invoice 412; purchasing documents, request for quote (RFQ), purchase order (PO), receiver, AP invoice 413; inventor documents 414; and third party (independent software vendor or ISV) documents 415. The data entry methods may be consistent with conventional data entry. Accordingly, there is no additional training needed by the end user.

When using the CDH 112, the posting process has been eliminated. Instead, the underlying data model stores the data in one set of tables according to the CDH 112. Corrections can be made on the document itself as needed. All reversing, correcting entries may be visible from the document originally entered. Journal entries 420 and distributions 430 may be made directly from the CDH 112.

Table 1 illustrates example tasks and how these tasks may be handled using the CDH of a business management platform implemented as a financial or accounting system.

TABLE 1

| Task | CDH model |
|---|---|
| Import or screen data entry | Data entry screen |
| Store data | In CDH tables |
| Enter AP transaction | Change status flag to Pending |
| Post GL | Change status flag to Posted |

Table 2 illustrates example CDH types which may be used for reporting in example modules of a business management platform implemented as a financial or accounting system.

TABLE 2

| | | | | |
|---|---|---|---|---|
| Transaction | Source | | Document | Posting |
| Description | Module | Document Type | Sub-type | Status |

General Ledger

| | | | | |
|---|---|---|---|---|
| Standard | GL | JE—Journal Entry | STD | Incomplete |
| Void GL | GL | JE—Journal Entry | VOID | Requisition |
| | | | | (Requested |
| Correction | GL | JE—Journal Entry | COR | Committed |
| Multiple | GL | JE—Journal Entry | MUL | Pending |
| Reversing | GL | JE—Journal Entry | REV | Actual |
| | | | | Budget |
| | | | | Budget |
| | | | | Custom |

Purchasing Module

| | | | |
|---|---|---|---|
| RFQ | AP | Request for Quote | |
| | | from | |
| PO | AP | Purchase Order | |
| AP Invoice | AP | AP - Vendor | INV |
| AP Credit | AP | AP - Vendor Credit | CM |

Sales Module

| | | | |
|---|---|---|---|
| Quote | AR | SA - Quotation | QUO |
| Sales Order | AR | SA - Sales Order | SO |
| AR Invoice | AR | AR - Sales Invoice | INV |
| AR Credit | AR | AR - Sales Credit | CM |

Third Party ISV - Project Module

| | | | |
|---|---|---|---|
| Timesheet | PROJ | PRO - Timesheet | TS |
| Employee | PROJ | PRO - Employee | EX |
| Expense | | Expenses | |
| Equipment | PROJ | PRO - Equipment | EL |
| Logs | | Logs | |
| Inventory | PROJ | PRO - Inventory | IV |
| Transfers | | Transfers | |
| Project | PROJ | PRO - Project | PP |
| Payables | | Payables | |

Budget Module

| | | | |
|---|---|---|---|
| Budget | BU | BU—Budget Base | STD |
| Standard | | | |
| Entry | | | |
| Void GL | GL | JE—Journal Entry | VOID |
| Correction | GL | JE—Journal Entry | COR |
| Multiple | GL | JE—Journal Entry | MUL |
| Reversing | GL | JE—Journal Entry | REV |

During use, data may be stored in the CDH platform. A screen or input routine stores data in the following core tables: Source Document table (JE->Journal Entry Table, AP—Account Payable, Header Table (see column B above), CDH table, and Distribution Table.

The Source Document table may be specific to the type of document, as shown in the table above. Each document type can have its own set of fields used for the particular type of document. General Ledger entries have their own header and are stored in the Journal Entry Table. The AP Header may have its own AP Header table. The Source Document table may hold all the non-CDH and non-Distribution data sets.

The CDH 112 allows for common elements to be treated according to a single set of coding. Accordingly, the CDH 112 simplifies the interface to different modules, eliminates duplicate processes, and maintains unique data elements in the Source Document table. The CDH 112 is flexible, and new modules or document types may be added. Those modules or document types can made to appear as native modules or documents to the end-user in the business management platform by complying with the CDH 112.

Data may be extracted from the CDH 112, e.g., by the ETL 440 for use by a processing application 450. During processing, the CDH table supplements the Source Document table with all core data elements, e.g., for operational, management, and fiscal reporting by the processing application 450. The output can be retrieved based any suitable data attribute (e.g., the document ID). For example, the Source Document ID is the GUID from the Source Document table. The document type comes from the interface for data entry form or import module.

The processing application 450 (e.g., a reporting module in this illustration) automatically inherits all the requisite data sets from the CDH and may generate a business action. By way of illustration, the business action may include generating reports, displaying data on a user dashboard, and data mining, to name only a few examples.

The posting status may also output as part of the business action. For example, status may include incomplete 460, requisition 461, committed 462, pending 463, and actuals 464, to name only a few examples. In an example, the posting status can be set by the user, such as in the GL.

In an example, the posting status may be limited by the module or interface to the module. For example Purchase Orders and Sales Orders may only be committed. Table 3 illustrates example posting status.

TABLE 3

| Type | Description |
|---|---|
| Incomplete | Any document in the process of creation or editing |
| | that has incomplete information that would lead to |
| | imbalance or incorrect information if examined, or a |
| | document that has errors in data or business logic. |
| Requisition | Documents that are requested by users as an initiating |
| | step but may later be rejected, such as purchase |
| | orders or requests for travel. |
| Committed | Purchase orders (AP) and Sales orders (AR) are |
| | non-limiting examples |
| Pending | Un-posted transactions but available |
| | in the operational and management reports. |
| Posted | Posted and locked down transactions |
| | included in financial reporting and would require |
| | corrective entries to make any adjustments |
| Custom Status | To be determined by end-user |

The distribution table may store the amount as entered on the original document in debit or credit. The distribution table may store the amount as the base debit or credit based on the currency conversion specified. Distributions may also store additional information used specifically for Cash Flow reporting.

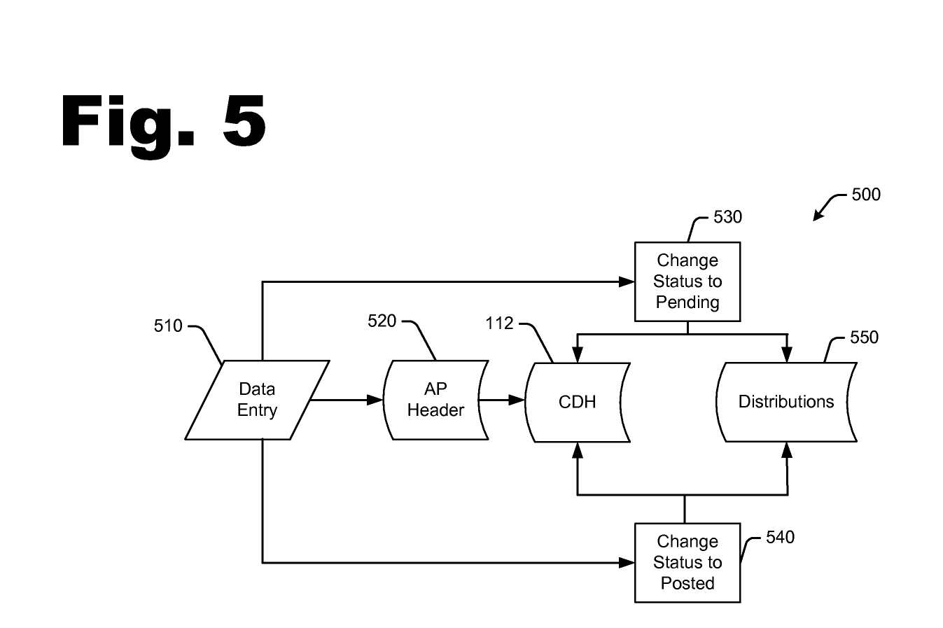

FIG. 5 illustrates an example process enabled by the business management platform using a common document header (CDH) 112. In FIG. 5, workflow 500 is illustrated for the business management platform implemented as a financial or accounting system. Data may be received via an invoice data entry module 510 (e.g., by the user entering or automatically) for accounts payable (AP). The data is appended with a header 520 and recorded in the CDH 112. The business management platform may monitor status and change a status flag to Pending at 530 when an un-posted AP is posted to the AP, or change the status flag to Posted at 540 when an un-posted GL is posted to the GL. The distribution table 550 may be updated based on the status.

It can be seen by the illustration shown in FIG. 5 that the CDH reduces the number of tables needed, and simplifies processing the data. For example, the following conventional work tables may be eliminated when using the CDH:
AP Invoice Header Work
AP Invoice GL Distribution Work
GL Header Work
GL Distribution Work
AP Invoice Header Open (replaced by the AP Header and CDH Document Header)
AP Invoice GL Distribution Posted (replaced by Distribution)

By eliminating these work tables, there is less maintenance. That is, common posting procedures can be handled by simply updating status flags to reflect posted status of a transaction. There is no moving of datasets, thus maintaining consistent data between ledgers and ledgers (e.g., the AP and GL). The process of correcting a distribution is improved because there is only one set of data for the General Ledger distribution, and anomalies can be reported on-the-fly because all entries for GL distribution are visible and entries needing correction show up immediately by the nature of the CDH. No special displays or routines are necessary, and correcting distributions and/or entries can be tied to original transactions, demonstrating complete corrected information while maintaining accounting compliance. There is no variance between the ledgers (e.g., the AP) and the main ledger (e.g., the GL), as these are treated as one and the same.

Before continuing, it should be noted that the examples described above are provided for purposes of illustration, and are not intended to be limiting. Other devices and/or device configurations may be utilized to carry out the operations described herein.

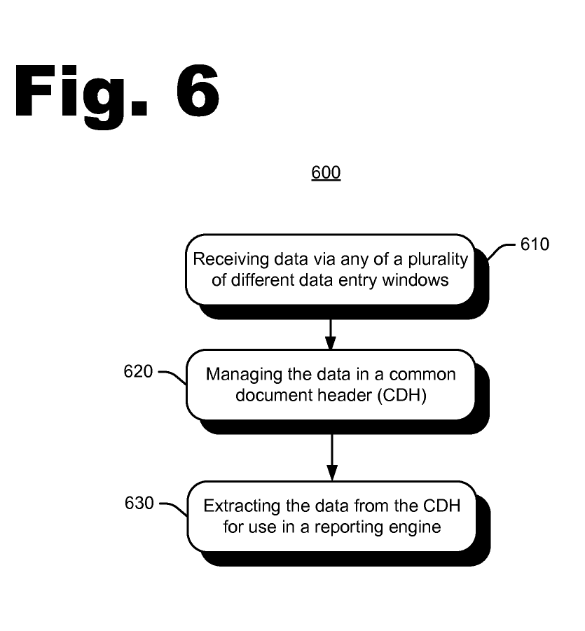

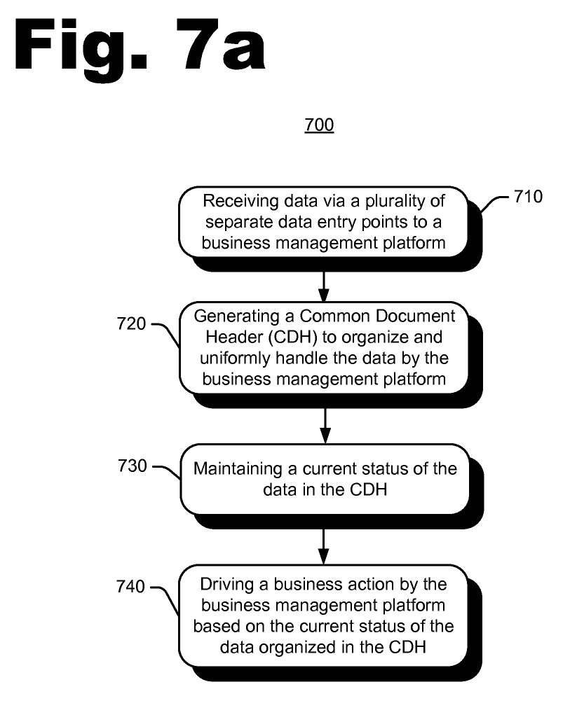

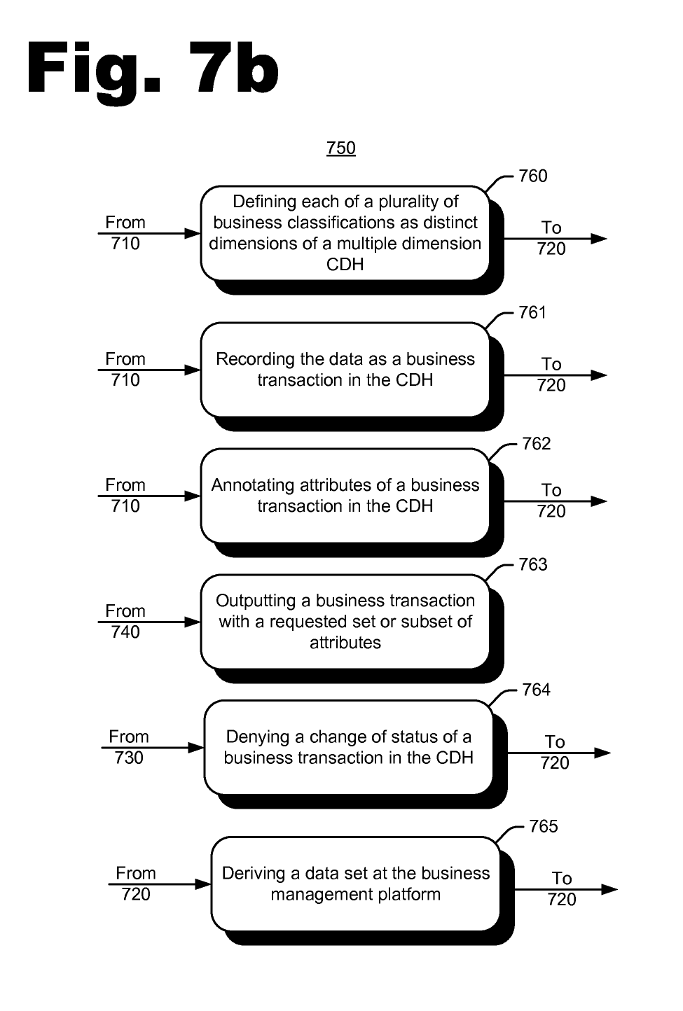

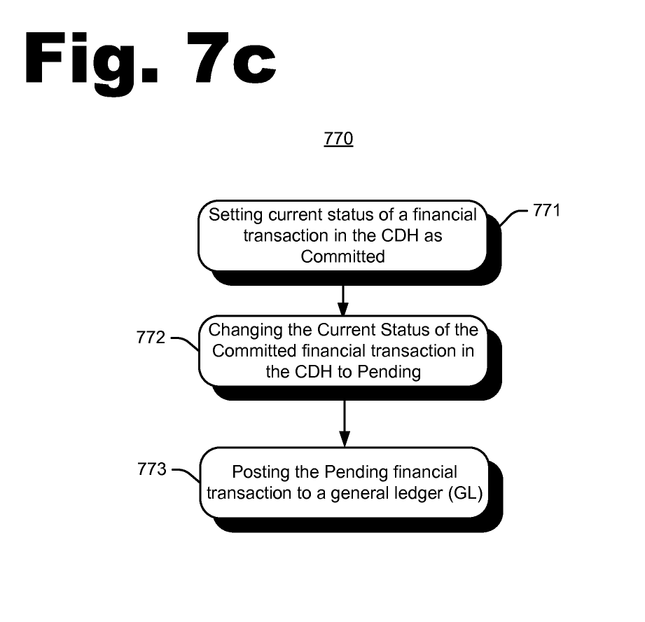

FIGS. 6 and 7a-c are flowcharts illustrating example operations. Operations may be embodied as logic instructions on one or more non-transient or non-transitory computer-readable medium. When executed on a processor, the logic instructions cause a general purpose computing device to be programmed as a special-purpose machine that implements the described operations. In an example, the components and connections depicted in the figures may be used.

FIG. 6 is a flowchart illustrating example operations 600 to implement a common document header (CDH) for a business management platform. Operation 610 illustrates receiving data (e.g., financial and/or operational data) via any of a plurality of different data entry windows. Operation 620 illustrates managing the data in a common document header (CDH). Operation 630 illustrates extracting the data from the CDH for use in a reporting engine.

In an example, the data in the CDH already resides in a general ledger (GL). Accordingly, the CDH eliminates having to bring the financial data from ledgers into a general ledger (GL), thereby reducing or altogether eliminating data corruption in the GL.

FIG. 7a is a flowchart illustrating example operations 700 to implement a common document header (CDH) for a business management platform. Operation 710 illustrates receiving data via a plurality of separate data entry points to a business management platform, the data describing at least some financial information and some operational information for a business. Operation 720 illustrates generating a common document header (CDH) to organize and uniformly handle the data by the business management platform. Operation 730 illustrates maintaining a current status of the data in the CDH. Operation 740 illustrates driving a business action by the business management platform based on the current status of the data organized in the CDH.

FIG. 7b is a flowchart illustrating example operations 750 to implement a common document header (CDH) for a business management platform. Operation 760 illustrates defining each of a plurality of business classifications as distinct dimensions of a multiple dimension CDH.

Operation 761 illustrates recording the data as a business transaction in the CDH, the business transaction having a set of attributes describing the business transaction.

Operation 762 illustrates annotating the set of attributes of the business transaction in the CDH.

Operation 763 illustrates outputting the business transaction with a requested set or subset of the attributes to a vertical business module associated with the business management platform.

Operation 764 illustrates denying a change of status of a business transaction in the CDH if allowing the change of status results in an error. Operation 765 illustrates deriving a data set at the business management platform, the derived data set based on the data in the CDH and describing a business transaction.

FIG. 7c is a flowchart illustrating example operations 770 to implement a common document header (CDH) for a business management platform. Operation 771 illustrates setting the current status of a financial transaction in the CDH as Committed. Operation 772 illustrates changing the current status of the Committed financial transaction in the CDH to Pending in response to receiving management approval. Operation 773 illustrates posting the Pending financial transaction to a general ledger (GL) after final processing.

The operations shown and described herein are provided to illustrate example implementations. It is noted that the operations are not limited to the ordering shown. Still other operations may also be implemented.

The operations may be implemented at least in part using an end-user interface, including but not limited to a web-based interface. For example, the end-user may make selections via the user interface which result in one or more of the operations described above being executed.

It is noted that the examples shown and described are provided for purposes of illustration and are not intended to be limiting. Still other examples are also contemplated.

1. A method comprising:
receiving data via a plurality of separate data entry points to a business management platform, the data describing at least some financial information and/or some operational information for a business;
generating a common document header (CDH) to organize and uniformly handle the data by the business management platform;
maintaining a current status of the data in the CDH; and
driving a business action by the business management platform based on the current status of the data organized in the CDH.

2. The method of claim 1, wherein the CDH has multiple dimensions, and further comprising defining each of a plurality of business classifications as distinct dimensions of the CDH.

3. The method of claim 1, further comprising recording the data as a business transaction in the CDH, the business transaction having a set of attributes describing the business transaction.

4. The method of claim 3, further comprising annotating the set of attributes of the business transaction in the CDH.

5. The method of claim 3, further comprising outputting the business transaction with a requested subset of the attributes to a vertical business module associated with the business management platform.

6. The method of claim 3, wherein the business transaction is a financial transaction, and further comprising:
setting the current status of the financial transaction in the CDH as Incomplete;
setting the current status of the financial transaction in the CDH as Requisitioned;
setting the current status of the financial transaction in the CDH as Committed;
changing the current status of the Committed financial transaction in the CDH to Pending in response to receiving management approval; and
posting the Pending financial transaction to a general ledger (GL) after final processing.

7. The method of claim 1, further comprising denying a change of status of a business transaction in the CDH if allowing the change of status results in an error.

8. The method of claim 1, further comprising deriving a data set at the business management platform, the derived data set based on the data in the CDH and describing a business transaction.

9. A computer program product including machine readable instructions stored on a non-transient computer-readable medium and executable by a processor, the computer program product comprising:
an interface module to receive data via a plurality of separate data entry points to a business management platform, the data describing at least some financial information and some operational information for a business;
a data management module to generate a common document header (CDH) to organize and uniformly handle the data by the business management platform, the data management module recording and managing the data in the CDH, the data management module maintaining a current status of the data in the CDH;
an extract transform load (ETL) module to extract the data from the CDH; and
a processing engine to output the extracted data in any of a plurality of modules to drive a business action based on the current status of the data organized in the CDH.

10. The computer program product of claim 9, wherein the CDH has multiple dimensions each defining one of a plurality of business classifications.

11. The computer program product of claim 9, wherein the CDH further records the data as a business transaction having a set of attributes describing the business transaction.

12. The computer program product of claim 9, wherein the CDH further records annotations to the business transaction.

13. The computer program product of claim 9, further comprising a derivation module to derive data for a transaction based on other data stored in the CDH.

14. The computer program product of claim 9, further comprising integrating with a vertical business module to further process the data.

15. The computer program product of claim 9, further comprising a notification module to generate a notification based on a change of status of a business transaction recorded in the CDH.

16. The computer program product of claim 9, further comprising a general ledger (GL) module to generate a financial report by accessing data in the CDH.

17. The computer program product of claim 9, wherein only status flags are changed to reflect status of the data in the CDH, without updating the data in each of a plurality of different data processing modules.

18. The computer program product of claim 9, wherein the data is updated automatically across all modules without reconciling ledgers and sub-ledgers.

19. The computer program product of claim 9 further comprising a financial management module to produce reconciled accounts as the data is residing inside a general ledger (GL), wherein sub-module data is reconciled at all times with a sub-module of the business management platform through balance validation in the GL, wherein entries in the sub-module of the business management platform are identified as “belonging” and “not belonging” in the sub-module of the business management platform.

20. A financial and business management system implemented as machine readable instructions stored on a non-transient computer-readable medium and executable by a processor to:
receive data via a plurality of separate data entry points, the data describing at least some operational information and some for financial information a business;
record the data as individual transactions in a multi-dimensional common document header (CDH);
organize the transactions in the CDH according attributes of the transactions, at least one of the attributes including a transaction status;
update the transaction status based on processing the transactions; and
output a business action based on the updated transaction status.
